(19) United States
(12) Patent Application Publication
(10) Pub. No.: US 2026/0297992 A1
(43) Pub. Date: Oct. 1, 2026

(54) ENGINE HOOD ARRANGEMENT FOR A MOTOR VEHICLE

(71) Applicant: Ford Global Technologies, LLC, Dearborn, MI (US)

(72) Inventors: Tobias Duffe, Köln (DE); Fabian Pritz, Leverkusen (DE); Naim Yildirim, Kocaeli (TR); Adil Oguz Kalaycioglu, Kocaeli (TR); Erdem Isbilen, Essex (GB); Burc Eltut, Kocaeli (TR)

(73) Assignee: Ford Global Technologies, LLC, Dearborn, MI (US)

(21) Appl. No.: 19/554,026

(22) Filed: Mar. 2, 2026

(30) Foreign Application Priority Data
Mar. 26, 2025 (EP) 25166297.9

(51) Int. Cl. E05B 83/24; E05D 3/06

(52) U.S. Cl. CPC E05B 83/24; E05D 3/06

(57) ABSTRACT

An engine hood arrangement for a motor vehicle has an engine hood which, in a closing position, closes an engine compartment access opening, and a hinge arrangement with a vehicle body-side base element and an engine hood-side pivoting element which, in the closing position, produces a positive fit on both sides with respect to a vertical axis. The engine hood is pivotable from the closing position to an opening position by a pivoting movement about a pivot axis and, from the opening position, is releasable from the vehicle body by an at least proportionately translational decoupling movement together with the pivoting element. A positioning arrangement spaced apart from the pivot axis has an engine hood-side positioning element and a vehicle body-side mating element which form a positive fit in the closing position. The positioning arrangement determines a position of the engine hood with respect to a horizontal axis.

### CROSS-REFERENCE TO RELATED APPLICATION

This application claims foreign priority benefits under 35 U.S.C. § 119(a)-(d) to European Application No. 25166297.9 filed Mar. 26, 2025, which is hereby incorporated by reference in its entirety.

### FIELD OF THE DISCLOSURE

The present disclosure generally relates to a hood arrangement for a motor vehicle.

### BACKGROUND OF THE DISCLOSURE

In motor vehicles such as cars or light trucks, the engine compartment is typically closable with a hood which can cover an upper opening and is pivoted to gain access to the engine compartment. This may be performed for maintenance purposes, such as refilling the windshield washer system, refilling or checking coolant or brake fluid, or servicing the powertrain or other components. With respect to the vehicle transverse axis, hinges may be provided on both sides in the region of the front support pillars, while a locking mechanism locks the hood from unintentional or unauthorized opening. In electric vehicles, it may be less necessary to allow the driver access to the compartment under the hood. Therefore, more permanent fastening systems can be used, but these should allow the hood to be opened for service purposes. Such fastening systems can be more efficient.

It would be desirable to provide for an enhanced secure attachment of an engine hood which allows easy access to the engine compartment.

### SUMMARY OF THE DISCLOSURE

According to a first aspect of the present disclosure, an engine hood arrangement for a motor vehicle has an engine hood which, in a closing position, closes an engine compartment access opening of a vehicle body, and a hinge arrangement. The hinge arrangement has a vehicle body-side base element and an engine hood-side pivoting element which, in the closing position, produces a positive fit on both sides with respect to a vertical axis. The engine hood is pivotable from the closing position to an opening position by a pivoting movement about a pivot axis running parallel to a transverse axis and, from the opening position, is releasable from the vehicle body by an at least proportionately translational decoupling movement together with the engine hood-side pivoting element. A positioning arrangement is spaced apart from the pivot axis. The positioning arrangement has an engine hood-side positioning element and a vehicle body-side mating element which form a positive fit in the closing position, as a result of which the positioning arrangement determines a position of the engine hood with respect to at least a horizontal axis which extends perpendicular to the vertical axis.

Embodiments of the first aspect of the present disclosure can include any one or a combination of the following features:

the positioning arrangement determines a position of the engine hood with respect to the transverse axis in the closing position;

the at least one hinge arrangement defines a range of movement of the pivoting element in relation to the base element with respect to the transverse axis;

the range of movement is at least 3 mm;

the positioning arrangement determines a position of the engine hood with respect to the longitudinal axis in the closing position;

the at least one positioning element projects along the vertical axis downward from the engine hood in the closing position;

a locking mechanism spaced apart from the pivot axis for locking the engine hood in the closing position;

an engine hood-side first locking element;

a vehicle body-side second locking element is arranged between two mating elements with respect to the transverse axis;

the vehicle body-side base element has at least one base guide surface, and the pivoting element has at least one pivoting guide surface;

at least one guide surface is formed in the shape of a circular arc and concentrically with respect to the pivot axis and a pivoting guide surface cooperates with a base guide surface that the pivoting guide surface is guided on the base guide surface during the pivoting movement;

the vehicle body-side base element comprises a hub portion having a base guide surface which cooperates with a pivoting guide surface of an arcuate portion, which is radially at the outside with respect to the pivot axis, of the pivoting element;

the hub portion and the arcuate portion in the closing position form a positive fit at least on one side with respect to the longitudinal axis and with respect to the vertical axis;

the engine hood-side pivoting element comprises at least one elastically deformable latching portion which forms a positive fit with the base element, the positive fit counteracting the translational decoupling movement and configured to be canceled by deformation of the latching portion;

the body-side base element comprises two cheek portions which are spaced apart along the pivot axis and define between the two cheek portions a receiving space for at least partially receiving the pivoting element, the receiving space transitioning into an insertion opening for the pivoting element;

the hinge arrangement comprises two spaced-apart hinge arrangements;

the engine hood-side positioning element comprises two spaced-apart positioning elements; and

the vehicle body-side mating element comprises two mating elements.

According to a second aspect of the present disclosure, an engine hood arrangement for a motor vehicle has an engine hood which, in a closing position, closes an engine compartment access opening of a vehicle body, and two spaced-apartment hinge arrangements. Each hinge arrangement has a vehicle body-side base element and an engine hood-side pivoting element which, in the closing position, produces a positive fit on both sides with respect to a vertical axis. The engine hood is pivotable from the closing position to an opening position by a pivoting movement about a pivot axis running parallel to a transverse axis and, from the opening position, is releasable from the vehicle body by an at least proportionately translational decoupling movement together with the engine hood-side pivoting element. A positioning arrangement is spaced apart from the pivot axis. The positioning arrangement has two spaced-apartment engine hood-side positioning elements and two vehicle body-side mating elements which form a positive fit in the closing position, as a result of which the positioning arrangement determines a position of the engine hood with respect to at least a horizontal axis which runs perpendicular to the vertical axis.

Embodiments of the second aspect of the present disclosure can include any one or a combination of the following features:

The positioning arrangement determines a position of the engine hood with respect to the transverse axis in the closing position;

the at least one hinge arrangement defines a range of movement of the pivoting element in relation to the base element with respect to the transverse axis;

the range of movement is at least 3 mm;

the positioning arrangement determines a position of the engine hood with respect to the longitudinal axis in the closing position;

the at least one positioning element projects along the vertical axis downward from the engine hood in the closing position;

a locking mechanism, spaced apart from the pivot axis, for locking the engine hood in the closing position;

an engine hood-side first locking element; and

a vehicle body-side second locking element preferably arranged between two mating elements with respect to the transverse axis.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a simplified front side perspective illustration of a front portion of a motor vehicle having a first embodiment of an engine hood arrangement according to the disclosure with an engine hood in a closing position;

FIG. 2 is a simplified front side perspective illustration of the front portion of the motor vehicle from FIG. 1 with the engine hood in an opening position;

FIG. 3 is a front perspective illustration of parts of the engine hood arrangement from FIG. 1;

FIG. 4 is a schematic front view of the engine hood arrangement from FIG. 1;

FIG. 5 is a cross-sectional illustration along line V-V in FIG. 4;

FIG. 6 is a schematic front view of a further embodiment of an engine hood arrangement;

FIG. 7 is a cross-sectional illustration along line VII-VII in FIG. 6;

FIG. 8 is a side perspective illustration of a hinge arrangement of the engine hood arrangement from FIG. 1;

FIG. 9 is an exploded perspective illustration of a base element of the hinge arrangement from FIG. 8;

FIG. 10A is a side view of the hinge arrangement from FIG. 8 with part of the engine hood in the closing position;

FIG. 10B is a side view of the hinge arrangement from FIG. 8 with part of the engine hood in the opening position; and

FIG. 10C is a side view of the hinge arrangement from FIG. 8 with part of the engine hood in a decoupled position.

### DETAILED DESCRIPTION OF PREFERRED EMBODIMENTS

In the different figures, identical parts are provided with the same reference signs, for which reason these parts are generally also described only once. It should be noted that the features and measures specified individually in the following description can be combined with one another in any desired technically meaningful way and disclose further refinements of the disclosure. The description additionally characterizes and specifies the disclosure, in particular in conjunction with the figures. The terms “first”, “second” etc. used in this application serve only for the purpose of differentiation. In particular, their use is not intended to imply any sequence or priority of the objects specified in conjunction with these terms.

With the entry of electrified vehicles into the motor vehicle market, many existing components in the engine compartment may become unnecessary. The excess space available due to the removal of these components allows for a front storage compartment, also known as the front trunk, sometimes abbreviated to “frunk.” Front trunks are loading regions which are located at the front of a vehicle and are typically accessible by opening the vehicle engine hood. Similarly, rear loading regions of vehicles with rear engines should be considered. Nevertheless, the term “engine compartment” and the term “engine hood” are used below, which are intended to also include the meaning of front compartment or rear compartment and front hood or rear hood or tailgate.

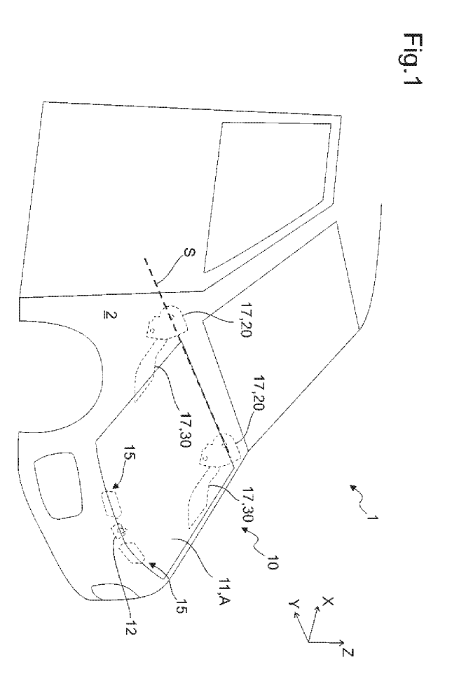

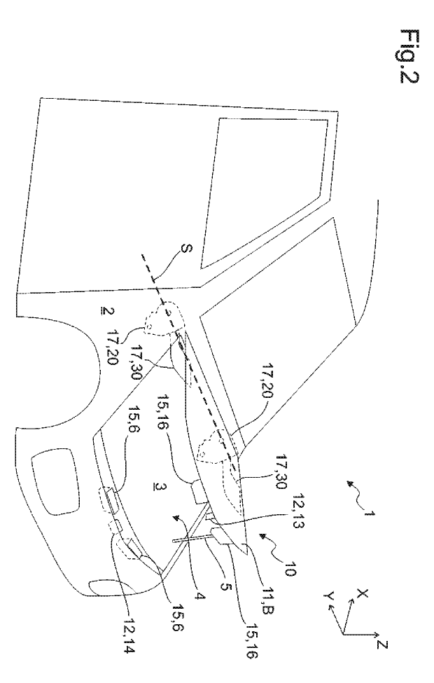

FIGS. 1 and 2 show a motor vehicle 1, for example an electric vehicle, comprising a vehicle body 2 which has an engine compartment 3 at the front with respect to a longitudinal axis X. The engine compartment 3 is accessible via an engine compartment access opening 4, which in turn is closable by an engine hood 11. FIG. 1 shows the engine hood 11 in a closing position A, while FIG. 2 shows an opening position B in which the engine hood 11 is put up and thus frees the engine compartment access opening 4. The opening position and closing position may also be referred to as the open position and closed position, respectively. The engine hood 11 is part of a first embodiment of an engine hood arrangement 10 according to the disclosure. The engine hood arrangements 10 comprises two hinge arrangements 17 which are arranged spaced apart relative to one another with respect to a transverse axis Y on the engine hood 11 and connect the engine hood 11 to the vehicle body 2. Each hinge arrangement 17 comprises a pivoting element 30 connected to the engine hood 11 and a base element 20 which cooperates therewith and is connected to the vehicle body 2. Furthermore, a locking mechanism 12 is provided, which comprises, as first locking element 13, a lock striker connected to the engine hood 11 and, a second locking element 14, as an associated lock on the side of the vehicle body 2. Furthermore, a positioning arrangement 15 can be seen, which comprises two engine hood-side positioning elements 16 and two vehicle body-side mating elements 6. In the closing position A, the positioning elements 16 positively cooperate with the mating elements 6, as a result of which a position of the engine hood 11 in the horizontal direction, that is to say perpendicular to the vertical axis Z, is determined.

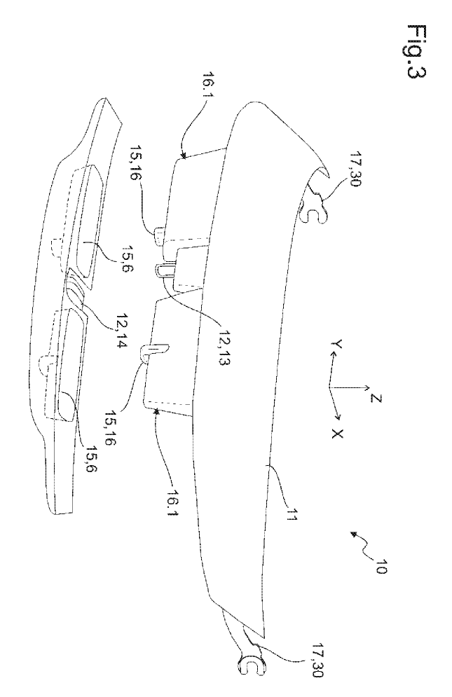

FIG. 3 is a perspective illustration of parts of the engine hood arrangement 10 from FIGS. 1 and 2. The illustration is more detailed and more precise in terms of dimensions than in FIGS. 1 and 2. The two positioning elements 16, which project with respect to the vertical axis Z downward from the engine hood 11, can be clearly seen. The two positioning elements 16 are spaced apart from one another with respect to the transverse axis Y, wherein the first locking element 13 is interposed between the two positioning elements 16. The relative position, illustrated in FIG. 3, of the engine hood 11 with the positioning elements 16 in relation to the mating elements 6 corresponds neither to the closing position A nor to the opening position B, but rather represents a decoupled state of the engine hood 11 in which the pivoting elements 30 are released from the base elements 20. However, the orientation with respect to the longitudinal axis X, the transverse axis Y and the vertical axis Z corresponds to those in the closing position A. The two mating elements 6 which here are formed in one piece with one another form cutouts which are dimensioned such that they can each positively receive one of the positioning elements 16. The positioning elements 16 may have beveled directing surfaces 16.1 which, when the engine hood 11 is being closed, ensure positionally secure insertion into the cutouts of the mating elements 6. The second locking element 14 is arranged between the mating elements 6, such that it in the closing position A can engage with the first locking element 13 and lock the engine hood 11.

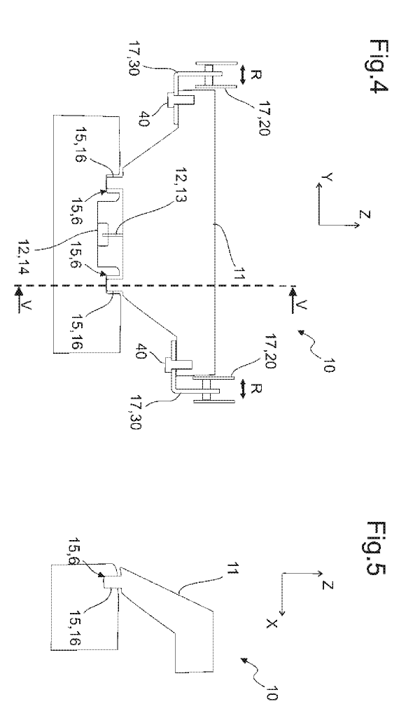

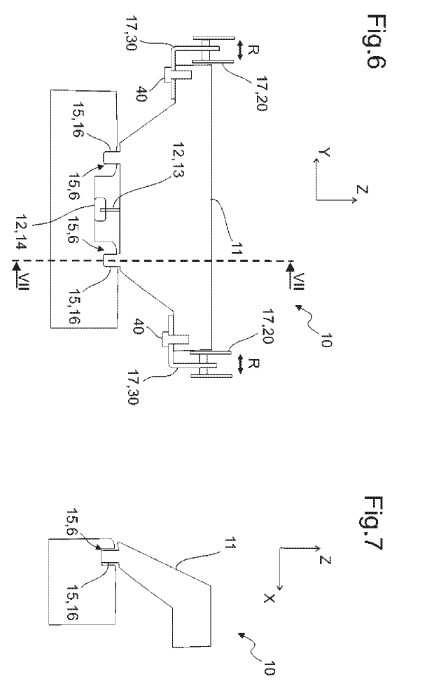

FIGS. 4 and 5 show, in highly schematic form, the engine hood arrangement 10 with the engine hood 11 in the closing position A. The shapes and relative dimensions of the individual components in FIGS. 4-7 deviate significantly from reality, which primarily serves for better illustration. The two pivoting elements 30 are connected to the engine hood 11 by fasteners such as screws 40. Owing to manufacturing and assembly tolerances, the positions of the pivoting elements 30 and their distance along the transverse axis Y cannot be precisely determined. In order to take this into account, each base element 20 defines with the associated pivoting element 30 a range of movement R with respect to the transverse axis Y. Within this range of movement R, which may be, for example, at least 1 mm, at least 3 mm, at least 5 mm or at least 7 mm and at most 10 mm, the respective pivoting element 30 taken in isolation can be positioned as required in relation to the base element 20. However, owing to the connection of the pivoting element 30 to the engine hood 11, the mentioned movability may be restricted. As will be explained below, the hinge arrangements 17 are designed such that they do not or only incompletely determine the position of the engine hood 11 with respect to the longitudinal axis X. The position is achieved by a positive engagement of the positioning elements 16 with the mating elements 6. These engage with one another in a play-free manner with respect to the longitudinal axis X. Therefore, forces acting along the longitudinal axis X between the engine hood 11 and the vehicle body 2 can also be taken up by way of the positioning arrangement 15. In this example, the engagement with respect to the transverse axis Y is not free of play, and therefore a relative movement is possible. However, this may already be restricted in comparison to the above-mentioned range of movement R. The range of movement R ensures in any case that the position of the engine hood 11 along the transverse axis Y can be adjusted without causing tension in the region of the hinge arrangements 17 or deformation of the engine hood 11. The position with respect to the transverse axis Y can also be determined by a positive fit of the locking elements 13, 14.

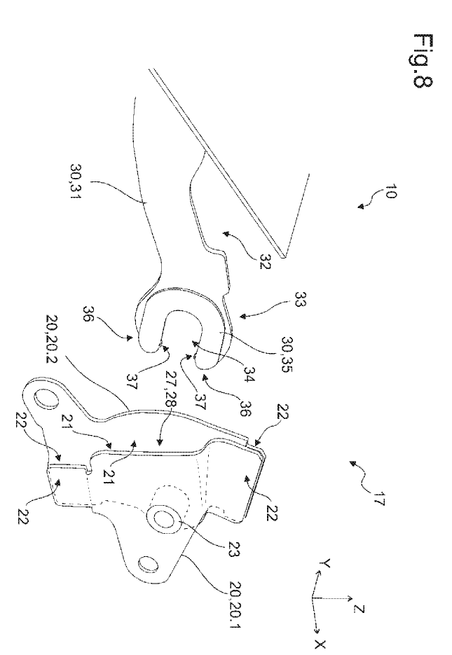

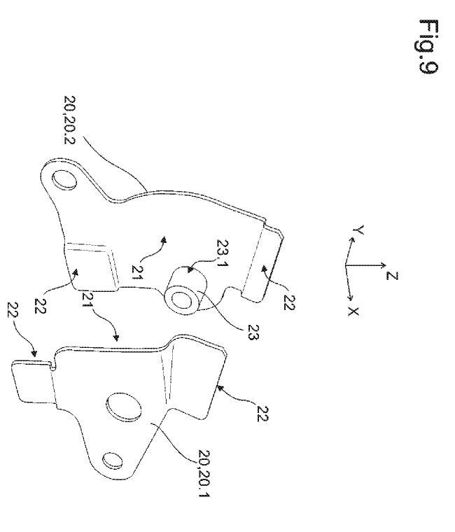

FIGS. 6 and 7 show, similarly to FIGS. 4 and 5, a further embodiment of an engine hood arrangement 10, which is largely identical to the first embodiment and in this respect is not explained again. However, provision is made in this case for the mating elements 6 to form with the positioning elements 16 a play-free positive fit with respect to the transverse axis Y and, in this respect, to determine the position of the engine hood 11. For this, a certain degree of play between the mating elements 6 and the positioning elements 16 in the direction of the longitudinal axis X is provided. This means that, in this embodiment, forces acting along the transverse axis Y can be transmitted by way of the positioning arrangement 15, while a certain degree of movability of the engine hood 11 in relation to the vehicle body 2 with respect to the longitudinal axis X is provided.

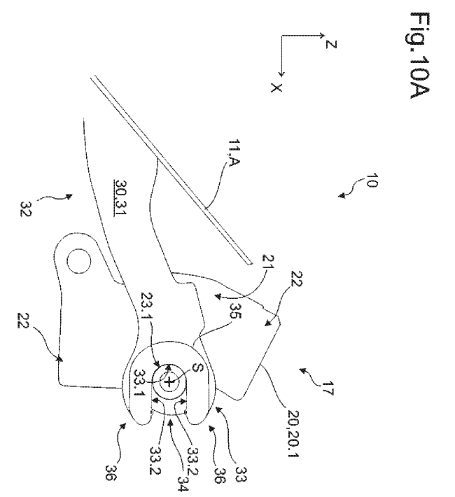

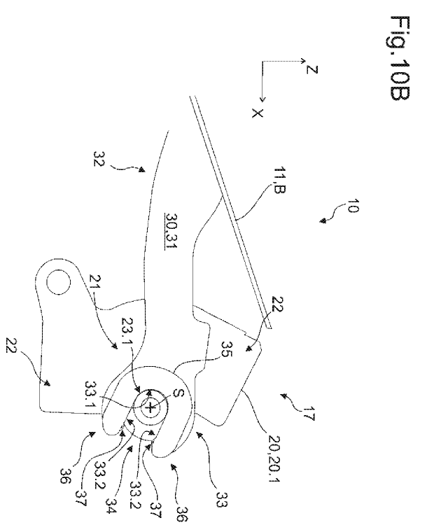

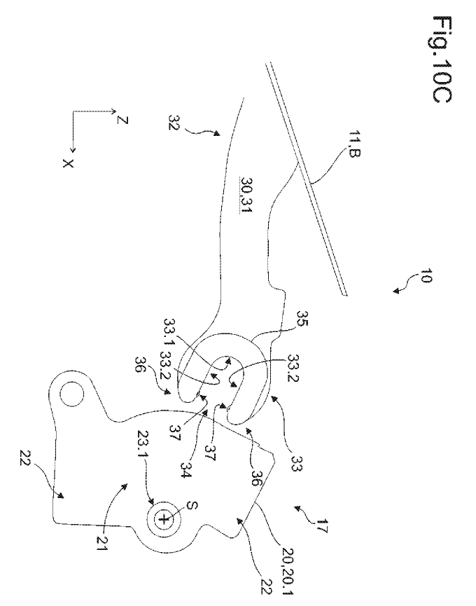

FIG. 8 is a perspective illustration of a hinge arrangement 15, while FIG. 9 is an exploded illustration of the associated base element 20. In this example, this base element 20 consists of two element parts 20.1, 20.2 each formed in one piece. A first element part 20.1 comprises a first cheek portion 21 which runs parallel to the longitudinal axis X and to a vertical axis Z. Projecting from the cheek portion 21 in the direction of the transverse axis Y is a hub portion 23. At the hub portion 23, a base guide surface 23.1 is formed, which is cylindrical (that is to say in the shape of a circular arc in the side view of FIGS. 10A-10C) and arranged concentrically with respect to a pivot axis S. The second element part 20.2 is in this case predominantly comprises a second cheek portion 21. Furthermore, both element parts 20.1, 20.2 comprise connecting portions 22 which may for example be welded to one another. When the two element parts 20.1, 20.2 are put together, the two cheek portions 21 are spaced apart relative to one another along the transverse axis Y and define between them a receiving space 27 for part of the pivoting element 30. In this case, an insertion opening 28 remains, through which the pivoting element 30 can be inserted. The receiving space 27 is dimensioned such that the above-mentioned range of movement R is provided. The pivoting element 30, which is connected to the engine hood 11, comprises a connecting part 31 and a latching part 35 connected therewith, for example by adhesive bonding. The connecting part 31 is of substantially rigid design and may, for example, consist of steel. The connecting part 31 forms an arm portion 32 which extends toward the engine hood 4. Furthermore, it forms an arcuate portion 33 together with the latching part 35. The latching part 35 may be manufactured from a comparatively elastic material such as spring steel or fiber-reinforced plastic. The latching part 35 comprises two latching portions 36 which lie opposite one another with respect to a cutout 34. Each latching portion 36 comprises a latching lug 37 which protrudes in the direction of the cutout 34. Each latching lug 37 comprises a cutout (without reference sign), which makes it easier to deform. The width of the cutout 34 is slightly greater than the diameter of the hub portion 23.

FIG. 10A shows a side view of a hinge arrangement 17 with part of the engine hood 11 in the closing position A, the second element part 20.2 having been omitted. The above-mentioned arcuate portion 33 is formed at the end of the arm portion 32. It has a pivoting guide surface 33.1, which in turn is arranged concentrically with respect to the pivot axis S. Its size is matched to the base guide surface 23.1. The pivoting guide surface 33.1 is adjoined by two displacement guide surfaces 33.2 which run parallel to one another and are oriented parallel to the longitudinal axis X in the closing position A shown in FIG. 10A. Together with the pivoting guide surface 33.1, they delimit the above-mentioned cutout 34 within the arcuate portion 33. In the closing position A in which the pivoting element 30 is partially arranged in the receiving space 27, a positive fit on both sides with respect to the vertical axis Z is produced between the pivoting element 30 and the base element 20. This is based on the cooperation of the arcuate portion 33 with the hub portion 23. Thus, no translational movement of the pivoting element 30 in relation to the base element 20 along the vertical axis Z is possible. Furthermore, a positive fit on one side with respect to the longitudinal axis X is provided, which is based on the cooperation of the arcuate portion 33 with the hub portion 23. A movement along the transverse axis Y is restricted by the mutually opposite cheek portions 21, but is not prevented within the scope of the range of movement R.

In order to open up the engine compartment 3, the locking mechanism 12 is released and then the engine hood 11 is pivoted about the pivot axis S with the respective pivoting element 30. Here, the positive fit between the positioning elements 16 and the mating elements 6 is also canceled. During the corresponding pivoting movement, the base guide surface 23.1 forms with the pivoting guide surface 33.1 a pair of surfaces which are guided on one another. As a result of the corresponding guidance, the pivoting movement is carried out in a defined manner. FIG. 10B shows the opening position B reached at the end of the pivoting movement. In the opening position, a partial positive fit between the pivoting element 30 and the base element 20 is still provided. However, as indicated in FIG. 2, the engine hood 11 may be supported in the opening position B by use of an engine hood support 5. In this case, the engine hood 11 is furthermore partially supported in relation to the vehicle body 2 by way of the pivoting element 30 and the base element 20. Forces along the vertical axis Z and along the longitudinal axis X are transmitted via the pivoting guide surface 33.1 and the base guide surface 23.1.

Proceeding from the opening position B, however, the engine hood 11 may also be completely removed. This is possible according to a decoupling movement defined by the profile of the displacement guide surfaces 33.2. The corresponding decoupling movement is translational, in this case obliquely to the longitudinal axis X. The decoupling guide surfaces 33.2 are guided along the base guide surface 23.1 of the hub portion 23. In order to be able to guide the latching lugs 37 past the hub portion 23, an elastic deformation of same, and possibly of the latching portions 36 as a whole, is necessary. Therefore, intermittently increased force is required in order to completely remove the engine hood 11. This provides the user with a haptic indication as to whether and when decoupling is effected. Lastly, the decoupled position shown in FIG. 10C is achieved, in which the pivoting element 30 is completely released from the base element 20. The engine hood 11 is coupled by a reverse movement sequence. Here, too, a deformation of the latching portions 36 is required, which in turn is associated with a noticeable increase in force for the user.

The disclosure provides an engine hood arrangement for a motor vehicle which enables a secure attachment of an engine hood and easy access to the engine compartment. The motor vehicle may in particular be a car but also a truck. In particular, it may be an electric vehicle, but an application in vehicles with an internal combustion engine is also possible.

The engine hood arrangement comprises an engine hood which in a closing position closes an engine compartment access opening of a vehicle body. The vehicle body can correspond to the sprung mass of the motor vehicle, that is to say, for example, the chassis and the body. The engine compartment access opening is an opening via which the engine compartment can be accessed in a finally assembled motor vehicle. The engine compartment access opening is normally formed in a paneling of the vehicle body. The engine compartment may be located at the front or at the rear with respect to the direction of travel of the motor vehicle. The access opening normally adjoins the top of the engine compartment, but it may for example also point forward or obliquely forward in the case of a front engine compartment or rearward or obliquely rearward in the case of a rear engine compartment. The engine hood closes the engine compartment access opening when it is in a closing position. The term “close” should not be understood in the sense of a fluid-tight closure, but rather refers to the fact that access to the engine compartment, that is to say intervention in the engine compartment, via the engine compartment access opening is not possible for a user. The engine hood may include metal, for example of steel or aluminum; in particular it may alternatively be manufactured from plastic or fiber-reinforced plastic.

Furthermore, the engine hood arrangement comprises at least one hinge arrangement which comprises a vehicle body-side base element and an engine hood-side pivoting element which in the closing position produce a positive fit on both sides with respect to a vertical axis. The term “hinge arrangement” should not be interpreted as restrictive, although the function of the hinge arrangement is at least partially comparable to a hinge. The hinge arrangement may also be referred to as a connecting arrangement or coupling arrangement. The hinge arrangement firstly comprises a vehicle body-side base element. This is preferably arranged stationarily on the vehicle body or may be regarded as part thereof. Furthermore, the hinge arrangement comprises an engine hood-side pivoting element which is arranged on the engine hood. It may be rigidly connected to the engine hood, this also including the possibility that it is formed entirely or partially in one piece with the engine hood. As also becomes evident below, the base element and the pivoting element can be compared at least in part with the two mutually movable parts of a hinge. In the closing position of the engine hood, the base element and the pivoting element cooperate with one another in such a way that they produce a positive fit with respect to a vertical axis. The positive fit is provided on both sides, that is to say both in the direction of the vertical axis and in the opposite direction. A translational movement of the engine hood in relation to the vehicle body along the vertical axis is either prevented or at least limited to a negligible extent by the positive fit. The positive fit can arrest the engine hood in particular with respect to the vertical axis, at least in the region of the hinge arrangement. Optionally, in the closing position, a positive fit at least on one side, possibly also on both sides, with respect to a longitudinal axis may also be provided.

In general, the terms “longitudinal axis”, “transverse axis” and “vertical axis” should not be interpreted as restrictive in this context, apart from the fact that the mentioned axes are aligned perpendicularly to one another in pairs. In general, they form a stationary reference system with respect to the vehicle body. In particular, however, they may be the vehicle longitudinal axis, the vehicle transverse axis and the vehicle vertical axis. However, other definitions are also conceivable, for example the longitudinal axis being able to correspond to the vehicle transverse axis or else being able to be oriented obliquely with respect to the vehicle longitudinal axis and to the vehicle vertical axis.

The engine hood is pivotable from the closing position to an opening position by a pivoting movement about a pivot axis running parallel to a transverse axis and, from the opening position, is releasable from the vehicle body by an at least proportionately translational decoupling movement together with the pivoting element. The pivot axis may extend in the region of the hinge arrangement, in particular through the hinge arrangement. As explained below, the pivot axis is preferably defined by the cooperation of the pivoting element and the base element. It may also be said that the engine hood is pivotable from the closing position to the opening position in a manner guided by the at least one hinge arrangement. In the opening position, the engine hood at least does not completely close the engine compartment access opening, with the result that access to the engine compartment may be possible. However, embodiments in which the opening position does not allow access to the engine compartment, since the distance between the engine hood and the adjoining paneling parts is too small, are also conceivable. In this case, the pivoting movement may preferably correspond to a pivot angle of at least 10° or at least 20°, such that the closing position and the opening position are clearly separated for a user. In some embodiments, the pivoting movement to the opening position may at least partially cancel the translational positive fit between the base element and the pivoting element. This means that at least partial translational decoupling may be effected. In any case, in the opening position the engine hood is decoupled from the vehicle body to such an extent that, proceeding from the opening position, it can be removed together with the pivoting element from the vehicle body and the base element. This is carried out by a decoupling movement, which is at least partially translational. The decoupling movement does not necessarily have to be linear, although this is preferred. It may also be a complex movement with a plurality of individual translational movements. Furthermore, the decoupling movement may also contain rotational movement components.

At least after the engine hood has been removed from the vehicle body, full access to the engine compartment access opening is possible. The opening position may possibly only serve as an intermediate position when disassembling the engine hood. However, it is also conceivable that access to the engine compartment is possible already in the opening position. In this case, the engine hood may, as required, remain connected to the vehicle body by way of the at least one hinge arrangement, it possibly also being additionally supported, for example by use of an engine hood support which is connected to the vehicle body and can be selectively folded in or out, as in the case of known engine hoods. The engine hood is released by the pivoting movement and the subsequent decoupling movement. The pivoting movement may be a prerequisite for the engine hood to be able to be released. This makes it easier for the user to perform the movement sequence, since it is clearly divided.

The decoupling movement may be carried out at least partially at an angle to the longitudinal axis (that is to say not parallel to the latter). In particular, it may be carried out proportionately along the vertical axis, such that the engine hood is lifted off from the vehicle body to some extent. A plurality of hinge arrangements may be provided. In particular, the engine hood arrangement may comprise two hinge arrangements spaced apart along the transverse axis. These correspond to some extent to the hinges of a known engine hood.

According to the disclosure, the engine hood arrangement comprises a positioning arrangement spaced apart from the pivot axis, comprising at least one engine hood-side positioning element and one vehicle body-side mating element which form a positive fit in the closing position, as a result of which the positioning arrangement determines a position of the engine hood with respect to at least a horizontal axis which runs perpendicular to the vertical axis. The positioning arrangement is spaced apart from the pivot axis and thus may also be spaced apart from the at least one hinge arrangement. It may be arranged in particular in a region of the engine hood that lies opposite the pivot axis with respect to the longitudinal axis. If, for example, the pivot axis is located at a rear end region of the engine hood, the positioning arrangement may be arranged at a front end region. Strictly speaking, this relates to the at least one positioning element which is arranged on the engine hood. It may be arranged in a fixed position on the engine hood and may optionally also be formed in one piece therewith. The at least one mating element is arranged on the vehicle body and may be arranged in a fixed position in relation to the at least one base element. It may be arranged in a region of the access opening that lies opposite the at least one mating element with respect to the longitudinal axis.

In the closing position, the at least one positioning element forms a positive fit with the at least one mating element. Here, provision may in particular be made for in each case one positioning element and one mating element to be assigned to one another and to form a positive fit with one another. For example, the positioning element may project from the engine hood, that is to say protrude in relation thereto, while the mating element defines a cutout into which the positioning element engages in the closing position. In principle, however, a reverse design in which the positioning element defines a cutout is also conceivable. At least one of the elements may have a beveled guide surface which is designed to cooperate with the respective other element in order to guide the at least one positioning element and at least one mating element to an intended relative position during the transition to the closing position. In the intended relative position, the above-mentioned positive fit is then provided. At least two positioning elements and at least two mating elements are provided. The positioning elements may be spaced apart from one another in the direction of the transverse axis. The same applies to the mating elements. While the positive fit is provided in the closing position, it may be able to be canceled by adjusting the engine hood to the opening position.

Overall, the positive fit between the at least one positioning element and the at least one mating element ensures that a position of the engine hood with respect to at least a horizontal axis is determined. It may also be said that the engine hood is arrested with respect to this horizontal axis. More specifically, the position is determined in relation to the at least one mating element and thus in relation to the vehicle body as a whole. It goes without saying that here any elastic deformations during operation of the motor vehicle that may cause the position of the engine hood or part thereof to change in the meantime are disregarded. The horizontal axis is an axis which runs perpendicular to the vertical axis, that is to say within the plane which is spanned by the longitudinal axis and the transverse axis. Insofar as the vertical axis corresponds to the vehicle vertical axis, the horizontal axis runs horizontally in the conventional sense, that is to say perpendicularly to the direction of action of gravity.

The action of the positioning arrangement complements the at least one hinge arrangement. While the latter brings about a positive fit on both sides with respect to the vertical axis, the positioning arrangement defines a position perpendicular to the vertical axis. This may lead to a relieving of load on the hinge arrangement, since it does not have to transmit forces acting perpendicular to the vertical axis, or only to a lesser extent. Above all, it may contribute to a more precise positioning of the engine hood in the horizontal direction, even if the at least one hinge arrangement does not permit such positioning owing to manufacturing and/or assembly tolerances. The more precise positioning is provided primarily in the region of the positioning arrangement, but may also affect the entire engine hood depending on the embodiment.

One refinement provides for the positioning arrangement to determine a position of the engine hood with respect to the transverse axis in the closing position. The engine hood is thus arrested with respect to the transverse axis when it is in the closing position. This means that the at least one positioning element and the at least one mating element form a complete positive fit with respect to the transverse axis, which does not allow any position displacements in this regard. In this embodiment, it is possible, but not necessarily required, that the positioning arrangement defines a range of movement with regard to the longitudinal axis.

As already indicated above, manufacturing tolerances of individual parts and tolerances when connecting parts can make it difficult to precisely match the positions of two pivoting elements and the positions of two associated base elements to one another. Specifically, there may be deviations with regard to the positions with respect to the transverse axis. Even if the distance between the pivoting elements were precisely matched to the distance between the base elements, both pivoting elements could be offset in the transverse direction, which would also cause the engine hood to be arranged offset with respect to the transverse axis. This is disadvantageous at least from an esthetic point of view, and possibly also from a functional point of view, for example because the engine hood cannot completely close the engine compartment access opening. In particular, in order to be able to compensate for such tolerances and prevent positioning errors, at least one hinge arrangement defines a range of movement of the pivoting element in relation to the base element with respect to the transverse axis. This means that the pivoting element and the base element are designed in such a way that their relative position with respect to the transverse axis is not precisely determined, but rather the pivoting element can be or is arranged as required within the range of movement. Reference may also be made to a movement clearance or play. The mentioned range of movement is given in relation to the respective hinge arrangement. The engine hood may be arrested overall in relation to the vehicle body despite the range of movement with respect to the transverse axis. This can be achieved in particular by the positioning arrangement, provided that this brings about an arresting action with respect to the transverse axis as described above. The range of movement defined by the hinge arrangement may be at least 1 mm, at least 3 mm, at least 5 mm or at least 7 mm. The range of movement may be at most 10 mm. This refers to the total available space, such that, in the case of a range of movement of 3 mm for example, the pivoting element is able to be offset by 1.5 mm on either side proceeding from a center position.

In addition or as an alternative to an arresting action with respect to the transverse axis, the positioning arrangement may bring about an arresting action with respect to the longitudinal axis in the closing position. This may be advantageous in particular if the at least one hinge arrangement does not bring about an arresting action with respect to the longitudinal axis, for example because it only produces a positive fit on one side with respect to the longitudinal axis. In this case, the position of the engine hood with respect to the longitudinal axis must be defined in a different way. In this embodiment, this is effected by way of an arresting action by the positioning arrangement. This is based on a play-free positive fit between the at least one positioning element and the at least one mating element.

One refinement provides for at least one positioning element to project along the vertical axis downward from the engine hood in the closing position. The positioning element thus protrudes along the vertical axis downward in relation to the engine hood. Such a projection along the vertical axis is advantageous for a positive fit both with respect to the longitudinal axis and with respect to the transverse axis. An associated mating element defines a corresponding cutout which recedes downward along the vertical axis. This may also be referred to as a depression.

The positioning arrangement is normally not provided to completely arrest the engine hood and thus prevent opening thereof. Rather, the engine hood arrangement may comprise a locking mechanism, spaced apart from the pivot axis, for locking the engine hood in the closing position, comprising an engine hood-side first locking element and a vehicle body-side second locking element. The locking mechanism may also be referred to as a lock mechanism. In this case, one of the locking elements may be in the form of a lock striker, while the other locking element forms the actual lock. In particular, the first locking element may be in the form of a lock striker and the second locking element may be in the form of a lock. Owing to their fundamentally different functions, the locking mechanism may be spaced apart from the positioning arrangement. This means that the first locking element may be spaced apart from each positioning element and the second locking element may be spaced apart from each mating element. An advantageous refinement provides for the second locking element to be arranged between two mating elements with respect to the transverse axis. Accordingly, the first locking element is arranged between two positioning elements with respect to the transverse axis. A positive fit with respect to the vertical axis is able to be produced by the locking mechanism, while the positioning arrangement permits at least one-sided movability with respect to the vertical axis. The locking elements may also produce a positive fit with respect to the longitudinal axis and/or with respect to the transverse axis. In particular, the locking elements may bring about an arresting action with respect to the transverse axis by way of a positive fit. In this respect, the locking mechanism may complement the action of the positioning arrangement, if the latter only brings about an arresting action with respect to the longitudinal axis.

One embodiment provides for the base element to have at least one base guide surface, wherein the pivoting element has at least one pivoting guide surface, wherein at least one guide surface is formed in the shape of a circular arc and concentrically with respect to the pivot axis and in each case a pivoting guide surface cooperates with a base guide surface in such a way that it is guided on the latter during the pivoting movement. Reference may possibly also be made to the fact that the pivot axis is defined by at least one pair of guide surfaces. Since one of the guide surfaces is formed in the shape of a circular arc and the two guide surfaces are guided on one another, the circle center of the circular arc corresponds to a pivot axis. The expression “shape of a circular arc” refers to the shape of the guide surface with respect to a section plane running perpendicular to the pivot axis. Overall, the guide surface may correspond, for example, to a cylinder shell or to part of a cylinder shell. The pivoting guide surface and the base guide surface form a guide, with them possibly being entirely or partially in sliding contact with one another. It may be the case that only one of the guide surfaces is formed in the shape of a circular arc or, in particular, both, which generally enhances the guiding characteristic.

In addition to the guiding function, the guide surfaces may also perform a supporting function. Provision may advantageously be made that, in the opening position, the pivoting element is supported on the base element by way of at least one pivoting guide surface and a base guide surface cooperating therewith. This of course results in support of the engine hood on the vehicle body. Thus, the weight of the engine hood can at least partially be supported on the vehicle body by way of the respective hinge arrangement. This makes it easier for the user to handle the engine hood and is particularly advantageous if the opening position is not used as a mere intermediate position when disassembling the engine hood, but rather the engine hood is intended to remain in the opening position for a longer period of time. Normally, the support of the pivoting element on the base element is equivalent to a positive fit at least on one side with respect to the vertical axis (provided that the vertical axis runs parallel to the direction of gravity).

According to one refinement, the base element comprises a hub portion having a base guide surface which cooperates with a pivoting guide surface of an arcuate portion, which is radially at the outside with respect to the pivot axis, of the pivoting element, wherein the hub portion and the arcuate portion in the closing position form a positive fit at least on one side with respect to the longitudinal axis and with respect to the vertical axis. The hub portion may be the portion which lies radially furthest inward with respect to the pivot axis, similar to the hub of a wheel. Accordingly, it has radially at the outside the mentioned base guide surface which cooperates with the pivoting guide surface of the arcuate portion. The arcuate portion is radially at the outside of the hub portion and may be formed at least partially in an arc-like manner. However, this arcuate shape may be limited to the pivoting guide surface. During the pivoting movement, the arcuate portion is guided radially at the outside on the hub portion. In the closing position, the two portions form a positive fit at least on one side, which is provided both with respect to the longitudinal axis and with respect to the vertical axis. Forces are transmitted in this case via the base guide surface and the pivoting guide surface. A positive fit on both sides is advantageously provided with respect to the vertical axis.

Advantageously, the arcuate portion defines a radially extending cutout which is delimited by the pivoting guide surface and two displacement guide surfaces which cooperate with the hub portion during the decoupling movement such that they are guided on the latter. It may be said that, during the decoupling movement, the hub portion is guided along the cutout out of the arcuate portion, and during the reverse movement, is inserted through the cutout into the arcuate portion. The pivoting guide surface defines the end of the cutout, while the displacement guide surfaces form the sides thereof. The distance between the displacement guide surfaces may advantageously be matched to the dimensions of the hub portion, such that they allow a movement of the pivoting element that is guided in a defined manner. The profile of the displacement guide surfaces defines the direction of the decoupling movement.

The pivoting element may comprise at least one elastically deformable latching portion which forms a positive fit with the base element, said positive fit counteracting the decoupling movement and being able to be canceled by deformation of the latching portion. The positive fit may be formed in particular with the above-mentioned hub element. Elastic deformation of the latching portion allows the latter to be guided past the hub element, as a result of which the pivoting element can either be removed from the base element proceeding from the opening position or can conversely be guided to the opening position. The latching portion may be formed in particular in the region of one of the above-mentioned displacement guide surfaces. Advantageously, two latching portions may also be formed, which may lie opposite one another for example with respect to the above-mentioned radial cutout. The respective latching portion may comprise a protruding latching lug. In order to ensure sufficient elasticity of the latching portion, the pivoting element may comprise an elastic latching element which is connected to a substantially rigid connecting element which in turn is connected to the engine hood. Thus, the latching portion may be of elastic design, while the pivoting element otherwise has a rigid, mechanically stable structure. In some embodiments, the elastic deformation may include a deformation of the latching lug. In order to enhance the elastic deformability of a latching lug, deformation may comprise a cutout.

The base element of at least one hinge arrangement may comprise two cheek portions which are spaced apart along the pivot axis and define between them a receiving space for at least partially receiving the pivoting element, the receiving space transitioning into an insertion opening for the pivoting element. The two cheek portions may form a positive fit on both sides along the pivot axis, and thus along the transverse axis, with the pivoting element. The two cheek portions may be formed in particular by separately manufactured elements, which have been subsequently connected to one another. The cheek portions are spaced apart, wherein the hub portion may serve as a spacer, that is to say may be interposed between the cheek portions in the direction of the pivot axis (that is to say the transverse axis). In the closing position and in the opening position, the pivoting element is arranged at least partially between the cheek portions in the receiving space. The receiving space may be dimensioned such that it defines the above-mentioned range of movement for the pivoting element. This means that the distance between the cheek elements along the transverse axis may be greater than a width of the pivoting element by the mentioned range of movement.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An engine hood arrangement for a motor vehicle, the engine hood arrangement comprising:
an engine hood which in a closing position, closes an engine compartment access opening of a vehicle body;
a hinge arrangement, the hinge arrangement comprising:
a vehicle body-side base element; and
an engine hood-side pivoting element which, in the closing position, produces a positive fit on both sides with respect to a vertical axis, wherein the engine hood is pivotable from the closing position to an opening position by a pivoting movement about a pivot axis running parallel to a transverse axis and, from the opening position, is releasable from the vehicle body by an at least proportionately translational decoupling movement together with the engine hood-side pivoting element; and
a positioning arrangement spaced apart from the pivot axis, the positioning arrangement comprising:
an engine hood-side positioning element; and
a vehicle body-side mating element which form a positive fit in the closing position, as a result of which the positioning arrangement determines a position of the engine hood with respect to at least a horizontal axis which extends perpendicular to the vertical axis.

2. The engine hood arrangement according to claim 1, wherein the positioning arrangement determines a position of the engine hood with respect to the transverse axis in the closing position.

3. The engine hood arrangement according to claim 1, wherein the at least one hinge arrangement defines a range of movement of the pivoting element in relation to the base element with respect to the transverse axis.

4. The engine hood arrangement according to claim 3, wherein the range of movement is at least 3 mm.

5. The engine hood arrangement according to claim 1, wherein the positioning arrangement determines a position of the engine hood with respect to the longitudinal axis in the closing position.

6. The engine hood arrangement according to claim 1, wherein the at least one positioning element projects along the vertical axis downward from the engine hood in the closing position.

7. The engine hood arrangement according to claim 1, further comprising:
a locking mechanism, spaced apart from the pivot axis, for locking the engine hood in the closing position,
an engine hood-side first locking element; and
a vehicle body-side second locking element which is preferably arranged between two mating elements with respect to the transverse axis.

8. The engine hood arrangement according to claim 1, wherein the vehicle body-side base element has at least one base guide surface, and the pivoting element has at least one pivoting guide surface, wherein at least one guide surface is formed in the shape of a circular arc and concentrically with respect to the pivot axis and a pivoting guide surface cooperates with a base guide surface that the pivoting guide surface is guided on the base guide surface during the pivoting movement.

9. The engine hood arrangement according to claim 1, wherein the vehicle body-side base element comprises a hub portion having a base guide surface which cooperates with a pivoting guide surface of an arcuate portion, which is radially at the outside with respect to the pivot axis, of the pivoting element, wherein the hub portion and the arcuate portion in the closing position form a positive fit at least on one side with respect to the longitudinal axis and with respect to the vertical axis.

10. The engine hood arrangement according to claim 1, wherein the engine hood-side pivoting element comprises at least one elastically deformable latching portion which forms a positive fit with the base element, the positive fit counteracting the translational decoupling movement and configured to be canceled by deformation of the latching portion.

11. The engine hood arrangement according to claim 1, wherein the body-side base element comprises two cheek portions which are spaced apart along the pivot axis and define between the two cheek portions a receiving space for at least partially receiving the pivoting element, the receiving space transitioning into an insertion opening for the pivoting element.

12. The engine hood arrangement according to claim 1, wherein the hinge arrangement comprises two spaced-apart hinge arrangements.

13. The engine hood arrangement according to claim 1, wherein the engine hood-side positioning element comprises two spaced-apart positioning elements.

14. The engine hood arrangement according to claim 13, wherein the vehicle body-side mating element comprises two mating elements.

15. An engine hood arrangement for a motor vehicle, the engine hood arrangement comprising:
an engine hood which, in a closing position, closes an engine compartment access opening of a vehicle body;
two spaced-apartment hinge arrangements, each hinge arrangement comprising:
a vehicle body-side base element; and
an engine hood-side pivoting element which, in the closing position, produces a positive fit on both sides with respect to a vertical axis, wherein the engine hood is pivotable from the closing position to an opening position by a pivoting movement about a pivot axis running parallel to a transverse axis and, from the opening position, is releasable from the vehicle body by an at least proportionately translational decoupling movement together with the engine hood-side pivoting element; and
a positioning arrangement spaced apart from the pivot axis, the positioning arrangement comprising:
two spaced-apartment engine hood-side positioning elements; and
two vehicle body-side mating elements which form a positive fit in the closing position, as a result of which the positioning arrangement determines a position of the engine hood with respect to at least a horizontal axis which runs perpendicular to the vertical axis.

16. The engine hood arrangement according to claim 15, wherein the positioning arrangement determines a position of the engine hood with respect to the transverse axis in the closing position.

17. The engine hood arrangement according to claim 15, wherein the at least one hinge arrangement defines a range of movement of the pivoting element in relation to the base element with respect to the transverse axis.

18. The engine hood arrangement according to claim 17, wherein the range of movement is at least 3 mm.

19. The engine hood arrangement according to claim 15, wherein the positioning arrangement determines a position of the engine hood with respect to the longitudinal axis in the closing position, wherein the at least one positioning element projects along the vertical axis downward from the engine hood in the closing position.

20. The engine hood arrangement according to claim 15, further comprising:
a locking mechanism, spaced apart from the pivot axis, for locking the engine hood in the closing position,
an engine hood-side first locking element; and
a vehicle body-side second locking element which is preferably arranged between two mating elements with respect to the transverse axis.
